(19) United States
(12) Patent Application Publication
(10) Pub. No.: US 2003/0099364 A1
(43) Pub. Date: May 29, 2003

(54) Playback manipulation of HTTP streamed content objects

(76) Inventors: Mark R. Thompson, Chandler, AZ (US); Nathan F. Raciborski, Jackson, WY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/997,519

(22) Filed: Nov. 28, 2001

(51) Int. Cl. H04H 5/00

(52) U.S. Cl. 381/14

(57) ABSTRACT

According to the invention, a method for playing a streamed content object using hypertext transport protocol (HTTP) transport is disclosed. In one step, a first portion of the streamed content object is received from a packet switched network using HTTP. The first portion is played at least partially coincident in time with the first listed receiving step. A second portion of the streamed content object is received. The second portion is not contiguous in the streamed content object to the first portion.

### BACKGROUND OF THE INVENTION

This invention relates in general to network file transfers and, more specifically, to streaming content with hypertext transfer protocol (HTTP).

Files are transferred over the Internet with HTTP and other file transfer protocols. HTTP transport is used to stream a content object from beginning to end without any playback manipulation. Even though HTTP is one of the most ubiquitous protocols for transferring files, other protocols have been developed for transport of streamed content. These transport protocols include Real™, Windows Media Audio™ (WMA) and Quicktime™, which are all proprietary protocols respectively owned by RealNetworks™, Microsoft™ and Apple™. These protocols are supported with custom server software sold by the proprietor of each protocol. The streamed content protocols in conjunction with the server software allow playback manipulation while downloading streamed content.

### BRIEF DESCRIPTION OF THE DRAWINGS

The present invention is described in conjunction with the appended figures:

FIG. 1 is a block diagram of an embodiment of a streamed content distribution system;

FIG. 2 is a block diagram of another embodiment of the streamed content distribution system;

FIG. 3 is a flow diagram of an embodiment of a process where a user streams delivery of a content object while manipulating playback;

FIG. 4 is a flow diagram of an embodiment of a process for streaming delivery of a content object with playback manipulation; and

FIG. 5 is a flow diagram of another embodiment of a process for streaming a content object with enhanced accuracy.

In the appended figures, similar components and/or features may have the same reference label.

### DESCRIPTION OF THE SPECIFIC EMBODIMENTS

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the spirit and scope of the invention as set for in the appended claims.

The present invention includes a method for playing a streamed content object using hypertext transport protocol (HTTP) that allows playback manipulation. While downloading the streamed content object, a user can select another playback point that is not contiguous with a current stream point. The new position in the file is determined and the stream corresponding to that new position is requested. In this way, a user can skip back and forth to any position in the streamed content object where HTTP transport is used.

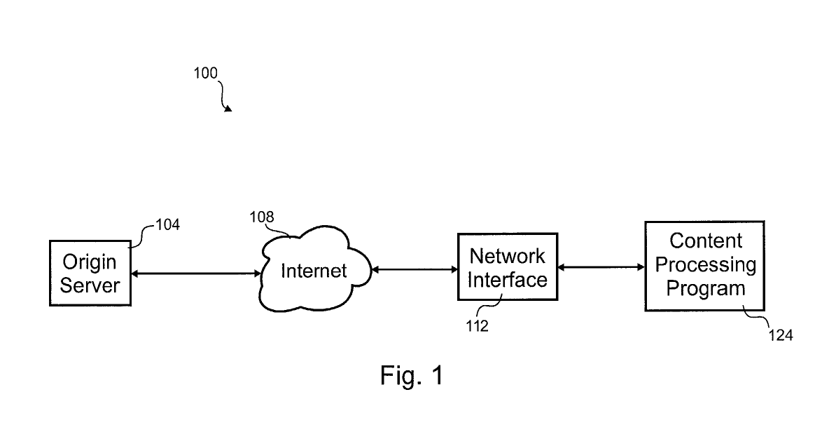

Referring first to FIG. 1, a block diagram of an embodiment of a streamed content distribution system 100 is shown. An origin server 104 provides content objects over the Internet 108 to a content processing program 124. The content processing program 124 communicates with the Internet 108 through a network interface 112. Although not shown, the origin server 104 also has a network interface.

The origin server 104 hosts content objects at a location that is typically remote to the content processing program 124. Software on the origin server 104 formulates web pages that are presented to a user associated with the content processing program 124. Links in the web pages are HTTP calls to content object files. Once a link is selected, a HTTP call is made to the origin server 104 to begin sending the content object file to the content processing program 124.

An operating system that underlies content processing program 124 communicates to the network interface 112 through an application program interface (API) or its equivalent. When the content object file is received from the network interface 112, the operating system recognizes the file type an invokes the content processing program 124 associated with that file type.

The content processing program 124 plays the streamed content object file as it is downloaded from the origin server 104. Audio or video could be played by the content processing program 124. Transports other than HTTP could be supported such as Real™, Windows Media Audio™ (WMA) and Quicktime™. Typically, the content object file is played from the beginning after streaming starts, but the user may want to skip ahead in the audio or video to a point away from the beginning. For example, the user may want to skip the opening credits from a movie. The content object file uses a streaming format such that the content processing program 124 can playback the content object file given any portion of the content within the file. With non-streaming formats, the whole file is downloaded before playback begins.

A slider bar, fast-forward button or rewind button in the content processing program allows the user to tell the content processing program 124 where the streamed content file should resume playing. For example, the user may begin downloading an unfamiliar song in the MP3 format. Soon thereafter, the user moves the slider to a point ten percent or thirty seconds into the song so that the user can quickly determine if the user wishes to listen to the song. The content processing program 124 determines the byte range of the content object file corresponding to the slider position and requests that byte range from the origin server 104. Once that byte range of the content object file begins to stream to the content processing program 124, the byte range is played.

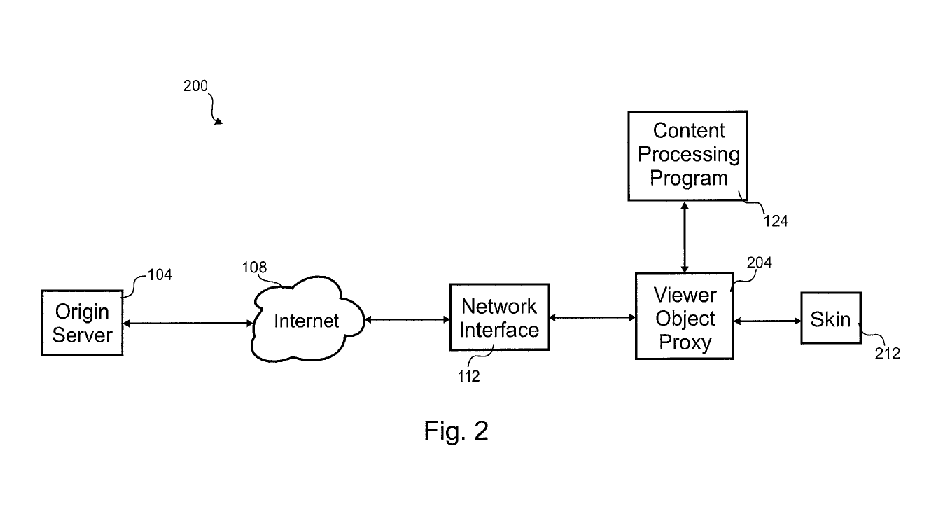

With reference to FIG. 2, a block diagram of another embodiment of the streamed content distribution system 200 is shown. In this embodiment, a content processing program 124 that does not natively have the capability to stream a content object using HTTP while still allowing manipulation of playback is used. To allow the processing program 124 to play HTTP streamed files, a viewer object proxy 204 and skin 212 are used. A user interfaces with the skin 212 for manipulation of playback.

From the perspective of the content processing program 124, it appears as if the user is requesting a content file using a transport mechanism native to the content processing program 124 even though unsupported HTTP transport is being used. This deception is performed by the skin 212 and viewer object proxy 204. The commands from the skin are translated by the viewer object proxy 204 to commands understood by the content processing program 124 that would cause streaming playback of a content object. For example, a request at the skin 212 for a file with HTTP transport would be translated to a request for a WMA file. The viewer object proxy 204 translates the WMA requests to HTTP requests that the origin server 104 understands.

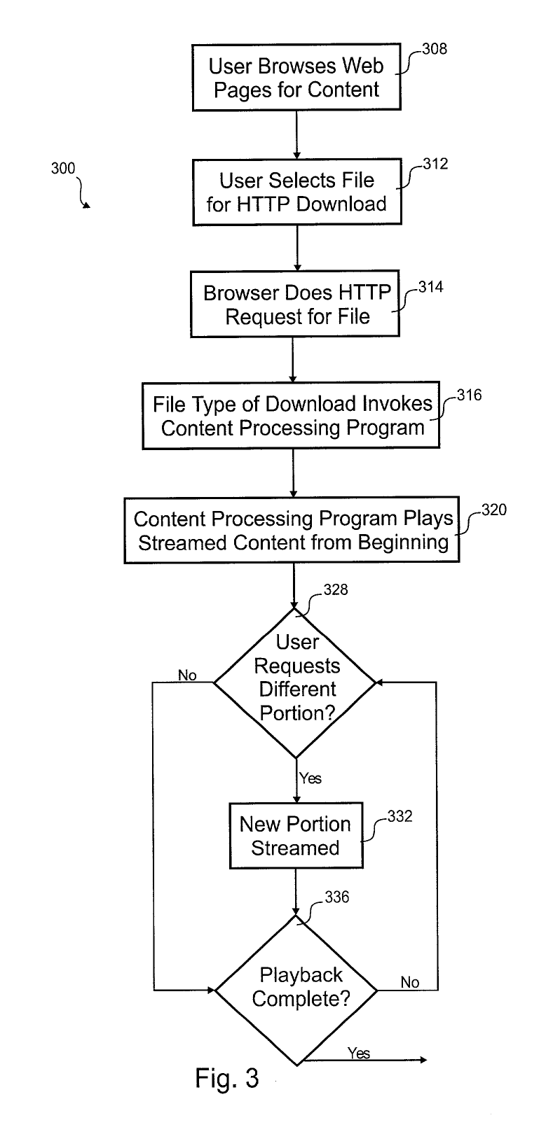

Referring next to FIG. 3, a flow diagram of an embodiment of a process 300 where a user streams delivery of a content object while manipulating playback is shown. The depicted process starts in step 308 where the user is browsing web pages for streamable content objects. In step 312, a content object file is selected for download from an origin server 104 that supports HTTP transport, but may not support other transport protocols. The browser does a HTTP request for the file in step 314.

The file type, as expressed in a file extension (e.g., .MP3, .RA, .MOV, .MPG, etc.), is passed the operating system to invoke an associated content processing program 124 in step 316. In step 320, the content processing program plays the streamed content from the beginning of the file. In step 328, the user may request another portion of the content object file that is discontinuous with the portion currently being played. If the discontinuous portion is requested, the corresponding byte range is requested and streamed in step 332. Alternatively, processing continues to step 336 if there is no request for a discontinuous portion.

Playback of the discontinuous portion cannot typically occur until the next key frame in the content object file for those file formats that have key frames. The content processing program 124 receives bytes in the requested byte range and waits until the next key frame before playing the audio or video. In some embodiments, the viewer object proxy 204 will not even pass the portion of the byte stream that occurs before the key frame such that the content processing program 124 can immediately begin playback. In yet other embodiments, the content processing program 124 can begin playback without a key frame such that in the case of MPEG video, for example, the images can be blocky for a period of time.

In step 336, a test is performed to determine if playback of the content object file is complete. Once the stream is completely downloaded and played or the user stops the download, playback is complete and the process ends. If playback is not complete, processing loops back to step 328. In this manner, the user interacts with the content processing program 124 to stream a content object using HTTP transport. Other embodiments, could use a skin 212 and content processing program 124 to stream a content object where the content processing program lacks native support for HTTP transport.

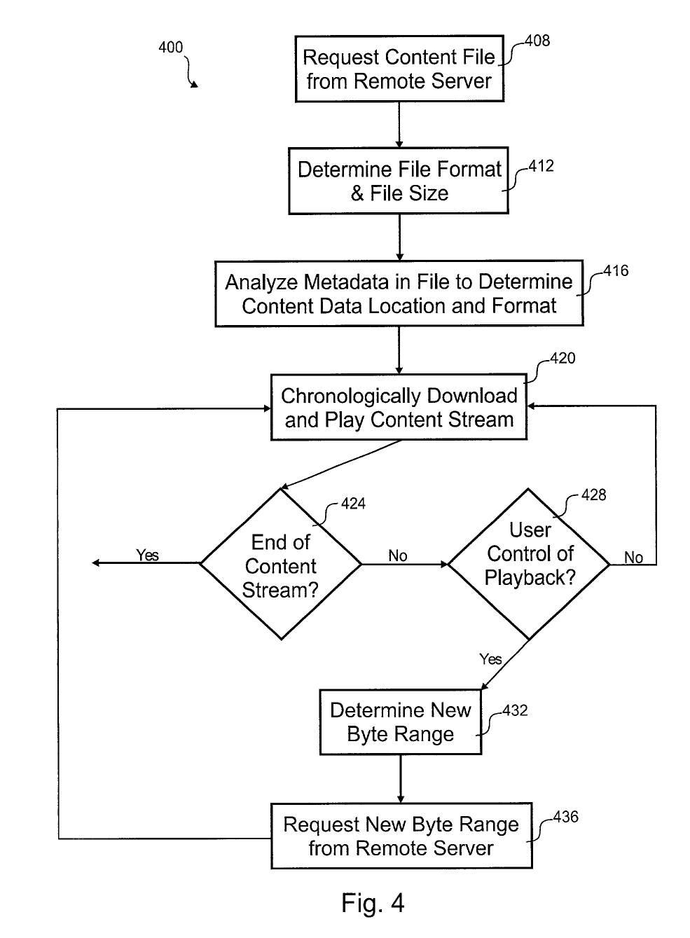

With reference to FIG. 4, a flow diagram of an embodiment of a process 400 for streaming delivery of a content object with playback manipulation is shown. The depicted process begins in step 408 where the content processing program 124 makes a HTTP request for a content object file from a remote origin server 104. The content processing program 124 is coupled to the origin server 104 by the Internet 108 or some other packet switched network.

In steps 412 and 416, the file to be downloaded is analyzed. The file format can be generally determined from the filename extension. The file length in bytes is determined from a HTTP header sent before the HTTP transport of the file. Knowing the file format allows determination how the data and headers in the file are interpreted. Within the file, a file header provides more information about the content within the file. Typically, bit rate, codec, and other format information is included in the file header.

Armed with this information about the content file, the location of the content within the file and format of that information is determined in step 416. For example, the filename might be “Beach Boys—Surfin' USA.MP3” with a file size of 2,890 kiloBytes. The extension of “.MP3” signifies that the file uses a MPEG-1 audio layer 3 format. Within the standard MP3 file header, the encoding rate of 160 kilobits per second could be specified along with the track time of two minutes and twenty-seven seconds. At this point, the portion of the content file that represents the audio can be determined, for example, the last 2,880 kiloBytes of the file could correspond to the audio data where the first 10 kiloBytes of the file is header information.

Download and playback of the audio data is performed in step 420. In step 424, a determination is made as to whether the stream download is complete. Presuming the download is not yet complete, processing continues to step 428 where any user control of playback is detected. Where there is no playback control, processing loops back to step 420 where the content file continues to download in a contiguous or chronological manner.

If the user does control the playback in step 428, processing branches to step 432 where the HTTP byte range to request is determined. The byte range in the content file for any portion of the video or audio data can be interpolated based upon a time or percentage specified by the user. Continuing with our above example, the user may move a slider in the content processing program 124 to indicate a position in the middle of the “Surfin' USA” song or approximately one minute and fourteen seconds into the song. Presuming a static encoding rate, the byte range would begin half way through the last 2,880 kiloBytes of the file or begin at 1,450 kiloBytes into the file. Once the new byte range is determined, it is requested from the origin server 104 using a HTTP byte request command in step 436. The content processing program 124 receives and plays the last half of the content object file after the process loops back to step 420.

In some file formats, a key frame is periodically sent in the data stream. Playback may not be possible until the next key frame is received. When receiving a non-contiguous portion of the context object, the content processing program 124 may wait for receipt of the next key frame before playback begins. As those skilled in the art can appreciate, playback control in the manner described above allows playing different portions of the content file that are not chronologically contiguous with HTTP transport.

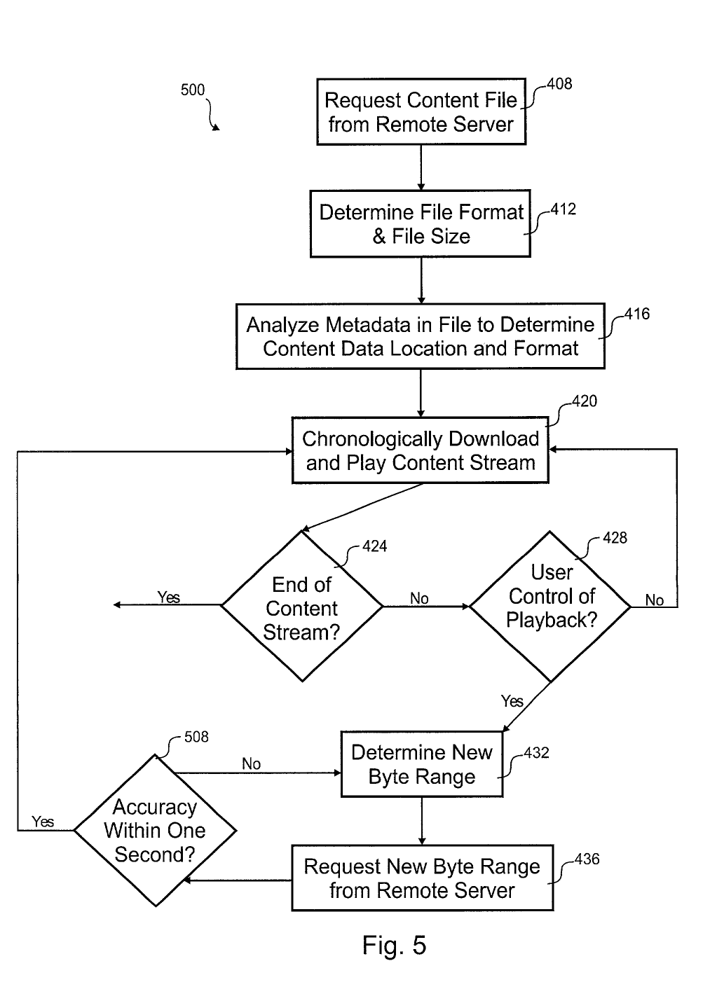

Referring next to FIG. 5, a flow diagram of another embodiment of a process 500 for streaming a content object with enhanced accuracy is shown. In certain file formats, the encoding rate can change periodically. Accordingly, a single interpolation may not provide sufficient accuracy. At the expense of a delay in switching to the new portion of the playback, an accuracy test in step 508 is added to this embodiment. If interpolation does not result in accuracy within one second or some other time period, the time stamp of the incorrect position is used to perform another interpolation such that the accuracy is iteratively achieved.

For example, a byte range beginning in the middle of a data portion of a content file is chosen if a point half way through a one minute song is requested. The next time stamp is retrieved from the data stream and checked against the interpolated estimate. In this example, the time stamp could indicate a point twenty seconds into the stream resulted from the first interpolation. An interpolation on the remaining forty seconds of the file is performed to estimate a second byte range to request and so on until one second accuracy is achieved. Although this embodiment uses one second accuracy, any time period, percentage or other increment could be used.

In light of the above description, a number of advantages of the present invention are readily apparent. For example, the ubiquitous HTTP transport can be used by content processing programs. Origin servers do not require proprietary software to support proprietary transports used today for streaming content. Additionally, conventional content processing programs without native support for HTTP transport can be coaxed to support HTTP transport by using a skin and a viewer object proxy.

A number of variations and modifications of the invention can also be used. For example, some embodiments could buffer any portions of the content object file that have been received from the origin server. Subsequent playback manipulation that specifies playback of a portion already downloaded could avoid requesting the stream from the origin server. In order to do this, the already downloaded portion could be retrieved from the buffer. As another example, the above embodiment uses a particular interpolation algorithm to determine the byte range, but other embodiments could use any known algorithm for determining the byte range.

While the principles of the invention have been described above in connection with specific apparatuses and methods, it is to be clearly understood that this description is made only by way of example and not as limitation on the scope of the invention.

What is claimed is:

1. A method for playing a streamed content object using hypertext transport protocol (HTTP) transport, the method comprising steps of:
receiving a first portion of the streamed content object from a packet switched network using HTTP;
playing the first portion at least partially coincident in time with the first listed receiving step; and
receiving a second portion of the streamed content object, wherein the second portion is not contiguous in the streamed content object to the first portion.

2. The method for playing the streamed content object using HTTP transport as recited in claim 1, further comprising a step of playing the second portion at least partially coincident with the second listed receiving step.

3. The method for playing the streamed content object using HTTP transport as recited in claim 1, further comprising a step of waiting for a key frame in the second portion before playing the second portion.

4. The method for playing the streamed content object using HTTP transport as recited in claim 1, wherein the first portion is played adjacent in time to the second portion without any playback in-between.

5. The method for playing the streamed content object using HTTP transport as recited in claim 1, further comprising a step of detecting user input related to playback control, wherein the second listed receiving step is at least partially responsive to the detecting step.

6. The method for playing the streamed content object using HTTP transport as recited in claim 1, further comprising a step of determining a byte range for the second portion.

7. The method for playing the streamed content object using HTTP transport as recited in claim 1, further comprising a step of determining a location of the second portion in the streamed content object.

8. The method for playing the streamed content object using HTTP transport as recited in claim 1, further comprising steps of:
requesting the first portion from a remote server
requesting the second portion from the remote server.

9. A method for playing a streamed content object using HTTP transport, the method comprising steps of:
receiving a first portion of the streamed content object using HTTP transport;
detecting user input corresponding to playback control of the streamed content object; and
receiving a second portion of the streamed content object that is, at least partially, in response to the detecting step.

10. The method for playing the streamed content object using HTTP transport as recited in claim 9, further comprising a step of playing the first portion at least partially overlapping in time with the first listed receiving step.

11. The method for playing the streamed content object using HTTP transport as recited in claim 9, wherein the playback control moves a playback point to a non-contiguous point in the streamed content object.

12. The method for playing the streamed content object using HTTP transport as recited in claim 9, further comprising steps of:
playing the first portion at least partially coincident with the first listed receiving step;
playing the second portion at least partially coincident with the second listed receiving step, wherein the first listed playing step is performed adjacent in time to the second listed playing step.

13. The method for playing the streamed content object using HTTP transport as recited in claim 9, further comprising a step of detecting user input related to playback control, wherein the second listed receiving step is at least partially responsive to the detecting step.

14. The method for playing the streamed content object using HTTP transport as recited in claim 9, further comprising a step of determining a byte range for the second portion.

15. A content playing product for playing a streamed content object using HTTP transport, the content playing product comprising:
code for receiving a first portion of a streamed content object using HTTP transport;
code for detecting user input corresponding to playback control of the streamed content object;
code for receiving a second portion of the streamed content object that is, at least partially, in response to the detecting step; and
a machine-readable medium comprising the codes.

16. The content playing product for playing the streamed content object using HTTP transport as recited in claim 15, further comprising code for playing the first portion at least partially overlapping in time with the first listed receiving step.

17. The content playing product for playing the streamed content object using HTTP transport as recited in claim 15, further comprising:
code for playing the first portion at least partially coincident with the first listed receiving step;
code for playing the second portion at least partially coincident with the second listed receiving step, wherein the first listed playing step is performed adjacent in time to the second listed playing step.

18. The content playing product for playing the streamed content object using HTTP transport as recited in claim 15, further comprising code for detecting user input related to playback control, wherein the second listed receiving step is, at least partially, responsive to the detecting step.

19. The content playing product for playing the streamed content object using HTTP transport as recited in claim 15, further comprising code for determining a byte range for the second portion.
